(19) United States
(12) Patent Application Publication
(10) Pub. No.: US 2002/0083072 A1
(43) Pub. Date: Jun. 27, 2002

(54) System, method and software application for incorporating data from unintegrated applications within a central database

(76) Inventor: Stacy Rhea Steuart, Lynchburg, VA (US)

Correspondence Address: Hunton & Williams, 1900 K Street, N.W., Washington, DC, 20006-1109, US

(21) Appl. No.: 09/742,103

(22) Filed: Dec. 22, 2000

(51) Int. Cl. G06F 17/30

(52) U.S. Cl. 707/102; 707/10

(57) ABSTRACT

A system, method and software application for collecting and combining data from data producing entities is provided. According to one aspect of the present invention, a method is provide which includes the steps of: creating an extract template for requesting specific data in a desired, standardized format from an unintegrated data-producing entity; transmitting the extract template to the unintegrated data-producing entity; creating an extract of data from within the unintegrated data-producing entity in conformance with the desired, standardized format of the extract template; transmitting the extract of data from the unintegrated data-producing entity to a central database; storing the extract of data.

### BACKGROUND OF THE INVENTION

The present invention relates generally to a system, method and software application for the use of data originating within information systems. More specifically, the invention relates to a system, method, and software application for efficiently combining data from a plurality of unintegrated applications.

Most business entities today acquire, process and store large amounts of data using a wide variety of information and computing systems. Collectively, these information and computing systems are commonly referred to as a “corporate data factory.” The main function of the corporate data factory is to collect and filter data in order to provide information and business intelligence for a plurality of decision makers throughout a business enterprise.

Data collection tools used by the modem corporate data factory generally include a plurality of different pieces of hardware and software. Included among these data collection tools are a plurality of data collecting applications, data warehouses, and data marts.

Within the corporate data factory, data collecting applications are comprised of systems and elements which enable business enterprises use to gather raw data. Generally, data collecting applications may be divided up into integrated applications (those applications that are a part of the formal corporate data factory) and unintegrated applications (those applications existing apart from the formal corporate data factory). More generally, unintegrated applications may include any applications which do not properly conform, for whatever reason, to a specific business enterprise's standards for data collection and storage.

Once collected within the corporate data factory, raw data from each of the data collecting applications is usually then transmitted from each data collecting application to an integration and transformation interface layer (I & T interface). In the I & T interface, the collected raw data is processed, filtered and customized so that it is ready for storage and retrieval. Generally, this output from the I & T interface is stored within large, general databases as well as within one or more smaller, specifically tailored databases. These tailored databases are generally referred to as data marts.

With reference to FIG. 1, operation of the corporate data factory as commonly practiced is illustrated. As shown in FIG. 1, raw data is collected from a plurality of different data-producing entities 12, 14, 16 within a corporate information structure 10 for a business enterprise. This collected raw data is then transferred to an I&T interface layer 18. Within the I&T interface layer 18, the collected raw data is converted to a standardized format and refined for inclusion in a data warehouse 20 of the business enterprise. Once stored within the data warehouse 20, the collected, standardized data is available for an organizational analysis 22. Furthermore, specific data within data warehouse 20 may be filtered down and stored within a plurality of specific tailored databases 24, 25, 26 within a data mart 30 for use by a specific business entity 28.

As presently configured, traditional corporate data factories work very well in accepting and combining data from a variety of integrated sources. With unintegrated sources, however, the methods and systems presently available have proven to be very unreliable and inefficient. Generally, in using traditional systems, even small variances in formatting may result in comprised data and unavailable information. Often, because of limitations in the present system, great time and expense are required for the I&T interface layer 18 to successfully filter and refine the collected data from unintegrated sources. In many cases, valuable data sources are completely excluded from any integrated data analysis because the time and expense to include the data is too great.

Accordingly, there is a need for an efficient, accurate and cost-effective method of integrating data from a plurality of unintegrated sources into a central data warehouse or a central database.

### SUMMARY OF THE INVENTION

The present invention overcomes the problems noted above and provides additional advantages, by providing a system, method and software application which enables users to efficiently and accurately combine data from unintegrated and integrated applications for common analysis and storage.

Additional advantages of the present invention will be set forth in part in the description which follows, and in part will be obvious from the description, or may be learned by practice of the invention. The advantages of the invention may be realized and attained by means of instrumentalities and combinations, particularly pointed out in the appended claims.

To achieve the advantages and in accordance with the purpose of the invention, as embodied and broadly described herein, in its broadest aspects, the present invention relates to a system for collecting and combining data from an unintegrated data-producing entity, wherein the system is comprised of: an extract template for requesting specific data in a standardized format from said unintegrated data producing entity; a transmitting element for transmitting said extract template to said data-producing entity; a means for creating an extract of data from within said unintegrated data-producing entity in conformance with the standardized format of said extract template; a transmitting element for transmitting said extract of data from said unintegrated data-producing entity; and a storing element for storing the transmitted extract of data.

In another aspect, the invention comprises a method for collecting and combining data within a data collection system; wherein said data collection system is comprised of an unintegrated data-producing entity and a database for storing data, said method comprising the steps of: creating an extract template for requesting specific data in a standardized format from said unintegrated data producing entity; transmitting said extract template to said data-producing entity; creating an extract of data from within said unintegrated data-producing entity in conformance with the standardized format of said extract template; transmitting said extract of data from said unintegrated data-producing entity to said database; and storing the transmitted extract of data for later access and retrieval.

In yet another aspect, the present invention comprises a computer readable medium including a software application for enabling the collection and combination of data within a data collection system, wherein said data collection system is comprised of an unintegrated data-producing entity and a database for storing data, said software application comprising: one or more instructions for creating an extract template for requesting specific data in a standardized format from said unintegrated data producing entity; one or more instructions for transmitting said extract template to said data-producing entity; one or more instructions for creating an extract of data from within said unintegrated data-producing entity in conformance with the standardized format of said extract template; one or more instructions for transmitting said extract of data from said unintegrated data-producing entity to said database; and one or more instructions for storing the transmitted extract of data for later access and retrieval.

The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a simplified schematic diagram of an arrangement for collecting and storing data as is known in the art.

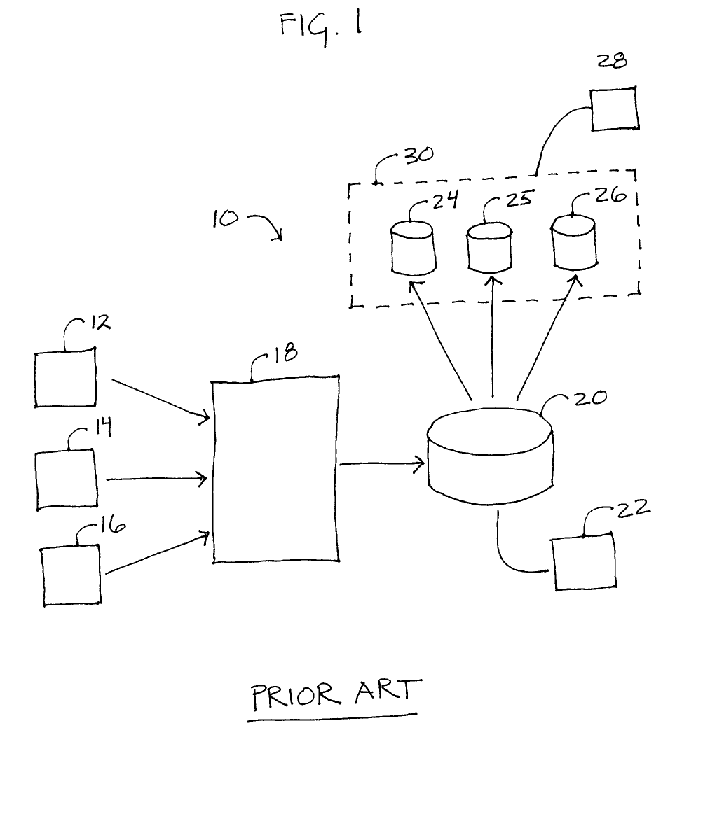

FIG. 2 is a simplified schematic diagram of an arrangement for collecting and storing data according to a first preferred embodiment of the present invention.

FIG. 3 is a flow chart illustrating a plurality of steps in a method for collecting and storing data in accordance with the present invention.

FIG. 4 is a simplified schematic diagram of an arrangement for providing access to the collected and stored data according to a preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawings in which like reference characters refer to corresponding elements.

The present invention provides for an efficient, accurate and cost-effective method, system and software application for incorporating data from unintegrated applications within a central database. While the invention is disclosed with respect to particular specific embodiments, it will be understood that the teaching of the present invention may have broad application in a wide variety of data processing environments and, thus, the particular specific embodiments are intended to be illustrative only.

For the purposes of the present application, an integrated application shall refer to an application which most closely conforms to a standardized format of a particular business enterprise's data processing system. An unintegrated application shall refer to an application which less closely conforms to the standardized format of a particular business enterprise's data processing system. Furthermore, regardless of any actual organizational relationships between two or more data-producing entities, for the purposes of the present application, a data-producing entity which uses an integrated application is referred to as an integrated data-producing entity and a data-producing entity using an unintegrated application is referred to as an unintegrated data-producing entity.

The system, method, and software application of the present invention described below, may preferably be implemented by an interactive computer software application incorporated within a computer-readable medium such as a hard disk drive, an optical medium such as a compact disk, or the like. Further, the computer-readable medium may be available to a user either locally on the user's computer or remotely over a computer network, such as a local area network (LAN) or through the Internet.

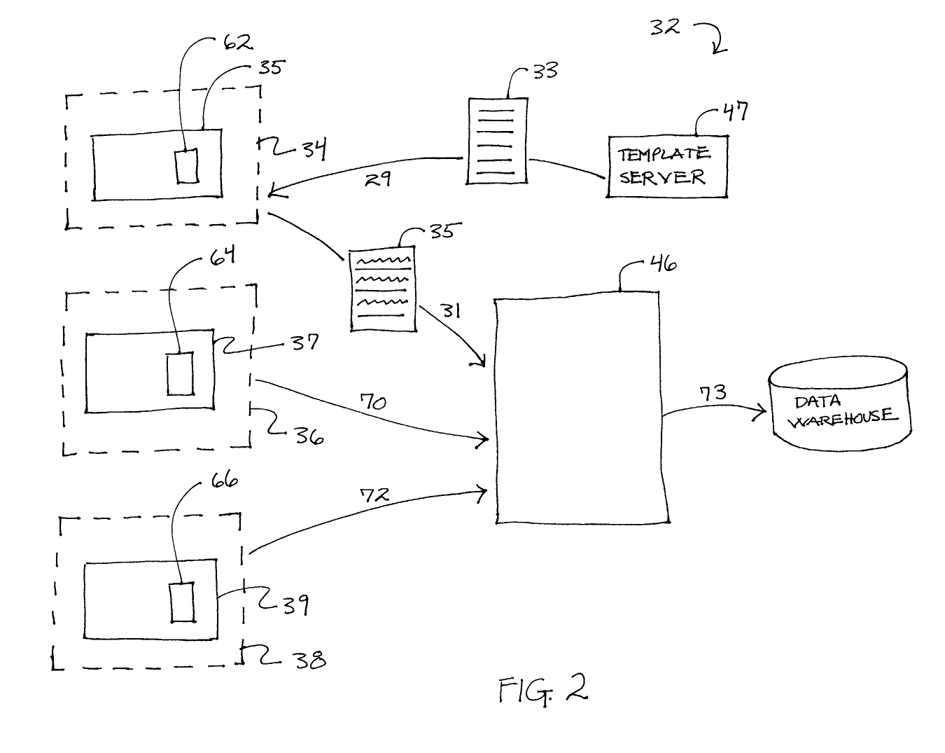

With reference to FIG. 2, one embodiment of a data processing system 32 to which the teachings of this invention may be applied is illustrated. As shown in FIG. 2, the data processing system 32 is provided with an unintegrated data-producing entity 34 running an unintegrated application 62 within a database server 35. The unintegrated data-producing entity 34 is connected to a template server 47 via a link 29 and to a data warehouse 48 via a database link 31. A plurality of integrated data-producing entities 36 and 38 are shown running integrated applications 64 and 66, respectively, within database servers 37 and 39, respectively. Furthermore, the integrated data-producing entities 36 and 38 are each connected via database links 70 and 72, respectively, to an Information and Transformation interface layer 46 (I&T interface layer 46). As shown, I&T interface layer 46 is connected to the data warehouse 48 via a database link 73. Additionally, the data warehouse 48 is shown connected to a plurality of databases 50, 52 and 54 in a data mart 56 via database links 76, 78 and 80, respectively.

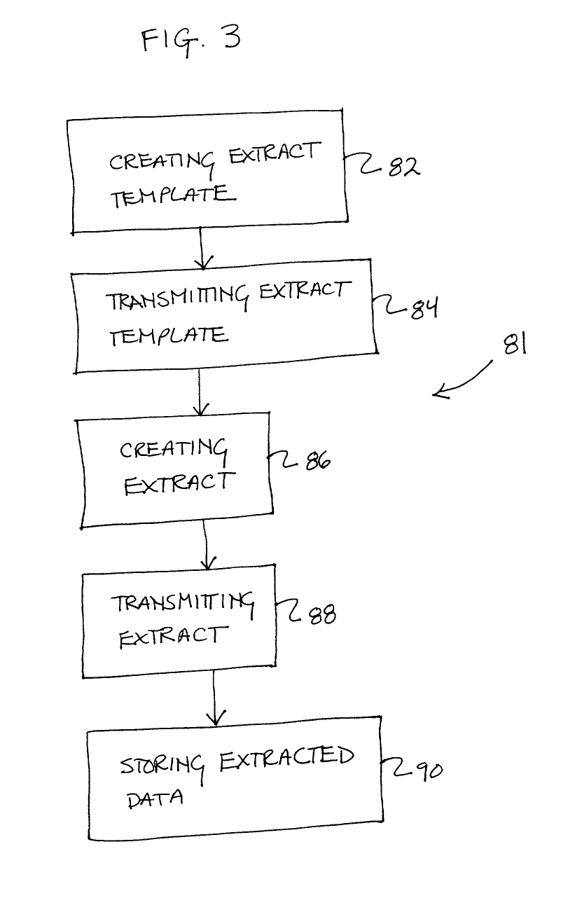

With further reference to FIG. 2 and the flow chart in FIG. 3, the operation of the system and method of the present invention will now be further discussed. As illustrated in FIG. 2, data originating in the integrated data-producing entities 36 and 38 is processed in a conventional manner. Accordingly, the integrated applications 64 and 66 each transmit and report raw data they collect directly to the I&T interface layer 46 via the database links 70 and 72. This collected and reported data is then processed, refined and transmitted to the data warehouse 48 via the database link 73.

With respect to data originating from the unintegrated application 62, in accordance with the present invention, this data is preferably produced and transmitted to the I&T interface 46 in response to an extract template 33. According to a preferred embodiment, the extract template 33 is preferably in the form of a set of database queries which request data in a format which is compatible with the standardized format of the integrated applications 64 and 66. Further in accordance with a preferred embodiment, extract template 33 is preferably comprised of a set of Standard Query Language (SQL) requests. Preferably, the SQL requests are in a form and in a structure which are easily processed and which produce an extract of data which is easily integrated by the I&T. Alternatively, extract template 33 may be comprised of any database request which is able to be processed and understood by the unintegrated application 62 and the programs of the I&T layer. In alternative embodiments, the extract template 33 may be comprised of either SQL or nonSQL requests.

For purposes of illustration and example, the extract template 33, as shown in FIG. 2, is preferably stored in and transmitted from template server 47 (Step 82 in the method shown in FIG. 3). Alternatively, the extract template 33 may be resident within the unintegrated database server 35 or within any other system or element accessible to the unintegrated data-producing entity 34. For instance, a plurality of functions performed by the template server 47 may be incorporated into the I&T interface layer 46.

Once created, template server 47 may transmit the extract template 33 to the unintegrated data-producing entity 34 via the link 31 (Step 84 as shown in FIG. 3). After receiving and analyzing the extract template 33, the unintegrated data-producing entity 34 may then create an extract of data 35 (Step 86) in conformance with the standardized format of the integrated applications 64 and 66, as dictated by the extract template 33. The unintegrated data-producing entity 34 may then transmit the extract of data 35 to the data warehouse 48 (Step 88) where it is stored in the data warehouse 48 (Step 90).

In accordance with a preferred embodiment of the present invention, the extract template 33 may be generated daily, weekly or at any interval necessary to facilitate the proper transfer of data from unintegrated sources. Additionally, extracts of data may likewise be generated and transmitted on a daily or week basis, or at any convenient interval.

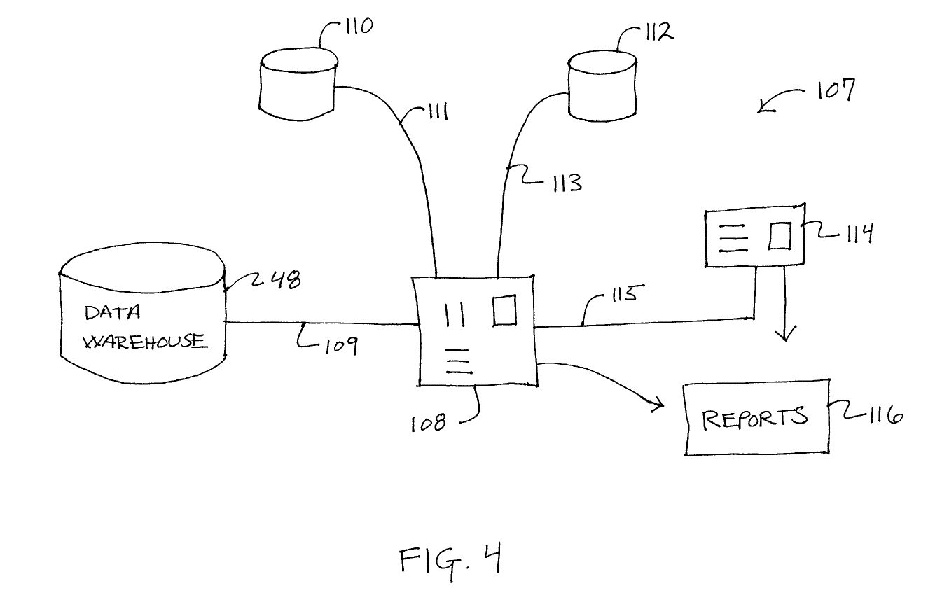

With reference now to FIG. 4, an example configuration 109 is provided which illustrates various preferred and optional methods for accessing data stored within the data warehouse 48. As illustrated, the information stored in the data warehouse 48 may preferably be accessed via a network server 108 via a database link 109. Alternatively, access may be provided to the data warehouse 48 for any terminal or computing device through any variety of modem, ISDN line or any other means including the Internet.

In the example configuration, the information stored in the database 48 may be made available for analysis and retrieval by a terminal 114 via the link 115 and the network server 108. Accordingly, the information within the data warehouse 48 may be made available through the terminal 114 for On Line Analytic Processing (OLAP) or any other processing or analysis which is desired. Additionally, in accordance with a preferred embodiment, data from other databases and data warehouses, such as example databases 110 and 112 connected via links 111 and 113, may also be accessed and included in any analysis. Additionally, a user may use terminal 114 and network server 108 to produce a variety of reports 116.

Accordingly, by employing the present invention, unintegrated data may be readily incorporated within a central data warehouse without slowing processing time of the overall data processing system thus allowing more data sources to be included for analysis and storage.

As is readily apparent from the above detailed description, the system, method and software application of the present invention may be used in a variety of network and database configurations in which data from unintegrated data-producing entities is combined in a central data warehouse. The system, method and software application of the present invention are also highly flexible and can be easily modified and customized to fit a plurality of specific situations. For instance, the schematic relationships illustrated in FIGS. 2 and 4 may be practiced within either a single computing resource, such as a mainframe environment, or in a distributed environment comprising a plurality of computing resources, such as in a client/server environment where access is provided either through a plurality of intelligent clients or through a plurality of dumb terminals. With respect to a networked environment, the present invention may be used within a plurality of different network arrangements including a local area network (LAN) using an Ethernet and/or a Token Ring access method, a metropolitan area network (MAN), or a wide area network (WAN), for example). Additionally, the present invention may also be used in a variety of operating system environments such as, for example, a Windows 95™, a Windows 98™, a Windows 2000™; a Unix™, an OS/2™ and/or a NetWare™ operating system environment.

According to a preferred embodiment, the applications 62, 64, 66 are preferably run and managed using an Oracle-compatible database system such as PowerMart™. Likewise, the I&T interface layer 46 is preferably formed from a plurality of Oracle-compatible programs. Within the scope of the present invention, however, each database may be comprised of any software that allows for the management of data structured in a plurality of fields and records and that is managed by a database management system (DBMS) such as a relational database produced by, for example, Sybase™, Microsoft™ and/or Informix™.

Moreover, according to a preferred embodiment of the present invention, each link within the data processing system 32 is preferably made using an interface such as an Open DataBase Connectivity interface (ODBC) to provide a connection and access to each database. However, the present invention may also be used with a network link based upon, for example, a Java DataBase Connectivity (JDBC) interface; a Network File System (NFS) link; a Web NFS link; a Server Message Block (SMB) link; a Samba link; a Netware Core Protocol (NCP) link; a Distributed File System (DFS) link, and a Common Internet File System (CIFS) link, which makes use of such transport protocols as, for example, TCP/IP, IPX/SPX, HTTP and/or NetBEUI.

The invention has been described with particular reference to preferred embodiments which are intended to be illustrative rather than restrictive. Alternative embodiments will become apparent to those skilled in the art to which this invention pertains without departing from its spirit and scope. Thus, variations and modifications of the present invention can be effected within the spirit and scope of the following claims.

What is claimed is:

1. A method for collecting and combining data within a data collection system; wherein said data collection system is comprised of an unintegrated data-producing entity and a database for storing data, said method comprising the steps of:
creating an extract template for requesting specific data in a standardized format from said unintegrated data producing entity;
transmitting said extract template to said data-producing entity;
creating an extract of data from within said unintegrated data-producing entity in conformance with the standardized format of said extract template;
transmitting said extract of data from said unintegrated data-producing entity to said database; and
storing the transmitted extract of data for later access and retrieval.

2. The method of claim 1, wherein said data collection system is further comprised of an integrated data producing entity, wherein said integrated data-producing entity transmits data to said database without the use of an extract template.

3. The method of claim 2, wherein said extract template is in the form of a set of database queries which request data in a specific format which is compatible with a format of said integrated application.

4. A system for collecting and combining data from an unintegrated data-producing entity, said system comprising:
an extract template for requesting specific data in a standardized format from said unintegrated data producing entity;
a transmitting element for transmitting said extract template to said data-producing entity;
a means for creating an extract of data from within said unintegrated data-producing entity in conformance with the standardized format of said extract template;
a transmitting element for transmitting said extract of data from said unintegrated data-producing entity; and
a storing element for storing the transmitted extract of data.

5. The system of claim 4, wherein said data collection system is further comprised of an integrated data producing entity, wherein said integrated data-producing entity transmits data to said database without the use of an extract template.

6. The system of claim 5, wherein said extract template is in the form of a set of database queries which request data in a specific format which is compatible with a format of said integrated application.

7. A computer readable medium including a software application for enabling the collection and combination of data within a data collection system, wherein said data collection system is comprised of an unintegrated data-producing entity and a database for storing data, said software application comprising:
one or more instructions for creating an extract template for requesting specific data in a standardized format from said unintegrated data producing entity;
one or more instructions for transmitting said extract template to said data-producing entity;
one or more instructions for creating an extract of data from within said unintegrated data-producing entity in conformance with the standardized format of said extract template;
one or more instructions for transmitting said extract of data from said unintegrated data-producing entity to said database; and
one or more instructions for storing the transmitted extract of data for later access and retrieval.

8. The software application of claim 7, wherein said data collection system is further comprised of an integrated data producing entity, and wherein said software application is further comprised of:
one or more instructions for transmitting data from said integrated data-producing entity data to said database without the use of an extract template.

9. The software application of claim 8, wherein said extract template is in the form of a set of database queries which request data in a specific format which is compatible with a format of said integrated application.
